(19) United States
(12) Patent Application Publication
(10) Pub. No.: US 2014/0003859 A1
(43) Pub. Date: Jan. 2, 2014

(54) Loose-Leaf Paper Binder and Notebooks Incorporating the Binders

(71) Applicant: Alejandra Miriam Santos, (US)

(72) Inventor: Alejandra Miriam Santos, (US)

(21) Appl. No.: 13/536,904

(22) Filed: Jun. 28, 2012

(51) Int. Cl. B42F 13/02

(52) U.S. Cl. 402/22

(57) ABSTRACT

The present disclosure relates to loose-leaf paper binders and notebooks incorporating the binders. More specifically, the present disclosure relates to loose-leaf paper binders that accommodate insertion of additional pieces of paper and removal of pieces of paper. Notebooks incorporating the binders provide for the individual pages to be rotated front-to-back and back-to-front without removal.

### FIELD OF THE INVENTION

The present disclosure relates to loose-leaf paper binders and notebooks incorporating the binders. More particularly, the present disclosure relates to loose-leaf paper binders that enable insertion of pieces of paper, removal of pieces of paper and repositioning of individual pieces of paper front-to-back and back-to-front without removal.

### BACKGROUND

There are many note-taking and paper binding systems in the market; however, the options currently available present various inconveniences: (1) Traditional notebooks do not allow removing unused pages, which results in unnecessarily wasted paper that cannot be used when a new notebook is needed. The waste increases consumer expenses (more notebooks are bought instead or utilizing the left over pages) and is not environmentally friendly. (2) Additionally, traditional notebooks do not allow reorganizing their contents; once a page is ripped off it cannot be re-attached. As a result, if a person chooses to have individual notebooks to make annotations on different subjects, he or she will be forced to carry around a considerable load due to the accumulation of the weight (e.g. a student taking mathematics, biology, science, algebra and literature would need to carry 5 different notepads). Sadly, most of the weight in a situation like this is unnecessarily carried as the majority of the blank pages on the notebooks are unlikely to be used on any single given day, but rather over time. It would be desirable to carry around only the few pages required for daily use. (3) An option that allows page reorganization comes in the form of binders. Unfortunately, binders are bulky, can be noisy upon opening and, some designs displaying only 3 holding rings do not distribute pulling tension appropriately which eventually can result in ripped pages that fall out. Furthermore, given that binder's rings tend to be designed to open in the center, it can be difficult to keep pages from falling when the binders are filled at maximum capacity. (4) Binders are also difficult to use on limited working spaces, such as small desks; their flat spine design and the fact that the front and back covers are typically fashioned as a single piece does not allow comfortably folding the pages over which can force the user to maintain the binder fully expanded at all times. (5) Additional customizable notebook systems allow paper insertion by using pre-cut slits on the pages' edges; however, the paper area around the slit gradually weakens upon continuous use increasing the likelihood of pages falling off over time. (6) Some customizable notebooks, have rings that separately attach to pages, the rings are not held together by any device, as a result, whenever the rings are to be used to create a new notebook, with new paper, they have to be individually removed and reset one by one, which is difficult (when all the rings are loose), unpractical and time consuming. Besides, adding pages into a notepad with this kind of system requires individually attaching each of the pages' perforations into their corresponding holding ring. (7) Lastly, although adding/removing one page at a time is viable using this system, trying to replace multiple pages at once can be problematic. A single page is pliable and thus easy to pull out, but a bunch (as little as 20 pages) become stiff and cannot be removed without force and considerable damage to the integrity of the pages' slit area. Once again, removing a large amount of pages requires considerable time and effort.

Loose-leaf paper binders and binder assemblies are formed in a variety of configurations. Metal ring binders that utilized a spring and a cam mechanism for holding the metal rings in the open and closed positions are described in U.S. Pat. Nos. 3,153,417 and 3,205,895. Such metal ring binder assemblies are complex to manufacture and expensive when compared to the binders of the present disclosure. Filling a split ring binder to capacity is awkward, split ring binders are bulky and typically include a flat back that is not conducive to be folded.

Attempts have been made to reduce the complexity and cost of the metal ring binders by using plastic, for example as described in U.S. Pat. Nos. 3,954,343 and 4,130,368. As opposed to making the binders less complex and less expensive, a complex cam mechanism is still used in each case to open and close the rings.

Often times, loose-leaf paper is manufactured with three holes to fit a standard three ring binder. With continued use, the paper tends to pullout of the binder since the area around the holes in the paper will pull or rip out. The pullout problem can be improved by increasing the number of rings in the binder. Adding rings to a standard metal ring binder is even more complex and expensive than the standard three metal ring binder.

Another common type of binder, typically referred to as a “comb binder,” that has multiple plastic fingers is described in U.S. Pat. No. 4,902,183. This binder is typically used for reports, where the loose-leaf pages are not to be readily inserted or removed. Due to the multiple fingers, the pullout problem is greatly improved. However, a comb binder typically requires use of a hand or machine operated release device that opens all the fingers simultaneously while the pages are being fed on the fingers or removed from the fingers. If a user does not have a release device, it is extremely difficult to insert a page to, or remove a page from a comb binder.

A loose-leaf paper binder is described in U.S. Pat. No. 4,511,274 that incorporates a two piece structure. Although the structure provides more than three rings and is less complex than a standard three ring binder or comb binder, the device does not allow the individual pages to be repositioned front-to-back or back-to-front without removal of the page(s). Additional deficiencies exist with regard to the need to align a backbone along two sides with respect to a second member when securing the corresponding paper within the device. Due to the fact that the backbone is not secured to the second member, the second member has to be rigid. The '274 device relies on deflecting the fingers out as the associated locking mechanism is disengaged. Deflecting the fingers may cause fracture over continued use.

### SUMMARY

In one embodiment a paper binder includes a main body having a plurality of fingers. The fingers comprise a first end connected to a backbone and at least a portion of the fingers comprise an enlarged second end, wherein the enlarged second ends have an enlarged second end thickness that is larger than a finger thickness. The paper binder also includes a closure having a slot and an interior portion, wherein a width of the slot is greater than the finger thickness and less than the enlarged second end thickness.

In another embodiment a paper binder includes a main body having a plurality of fingers. The fingers include a first end connected to a backbone and at least a portion of the fingers have an enlarged second end, wherein the enlarged second end has an enlarged second end thickness that is larger than a finger thickness. The paper binder also includes a closure having a slot and an interior portion, wherein a width of the slot is greater than the finger thickness and less than the enlarged second end thickness An enlarged second end of the finger at the end of the main body corresponding to an open end of the closure includes a male fastener portion configured to engage a closure female fastener portion.

In a further embodiment a paper binder includes a main body having a plurality of fingers. The fingers include a first end connected to a backbone and at least a portion of the fingers have an enlarged second end, wherein the enlarged second ends have an enlarged second end thickness that is larger than a finger thickness. The paper binder also includes a closure that has a slot and an interior portion, wherein a width of the slot is greater than the finger thickness and less than the enlarged second end thickness, wherein at least one enlarged second end is friction fit with the interior portion of the closure.

### BRIEF DESCRIPTION OF THE FIGURES

FIG. 1A depicts a perspective view of a lose-leaf paper binder assembly;

FIG. 1B depicts an exploded, perspective view of a first portion of a lose-leaf paper binder assembly;

FIG. 1C depicts an exploded, perspective view of a second portion of a lose-leaf paper binder assembly;

FIG. 2A depicts a perspective view of a main body portion of a lose-leaf paper binder;

FIG. 2B depicts an exploded perspective view of a section of a main body portion of a lose-leaf paper binder;

FIG. 3A depicts an exploded, perspective view of a closure of a lose-leaf paper binder;

FIG. 3B depicts a perspective view of a first end of a closure of a lose-leaf paper binder;

FIG. 3C depicts a perspective view of a second end of the closure of a loose-leaf paper binder opposite the end depicted in FIG. 3B and

FIG. 4 depicts a perspective view of a fastener for a closure of a lose-leaf paper binder.

The novel features which are believed to be characteristic of the invention, both as to its organization and method of operation, together with further objects and advantages thereof, will be better understood from the following description in connection with the accompanying drawings in which a presently preferred embodiment of the invention is illustrated by way of example. It is expressly understood, however, that the drawings are for purposes of illustration and description only, and are not intended as a definition of the limits of the invention.

### DETAIL DESCRIPTION

A loose-leaf paper binder is provided that allows insertion of individual pieces of paper, removal of individual pieces of paper and repositioning of individual pieces of paper from front-to-back and back-to-front without being removed from the binder. Additionally, the individual pieces of paper may be rotated front-to-back or back-to-front, such that the individual pieces of paper remain unfolded and occupy desk, or table top, space associated with a single piece of paper (i.e., rather than requiring space for side-by-side pieces of paper, such as when a typical three ring binder is opened).

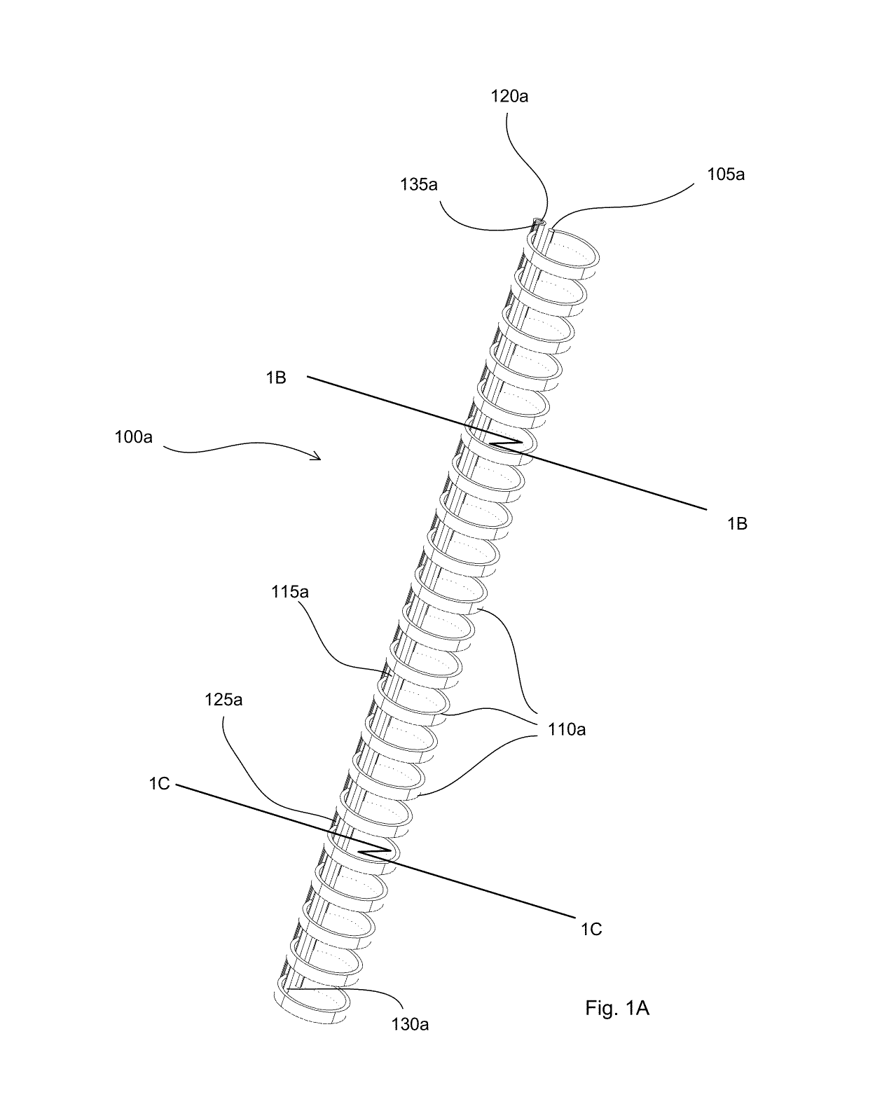

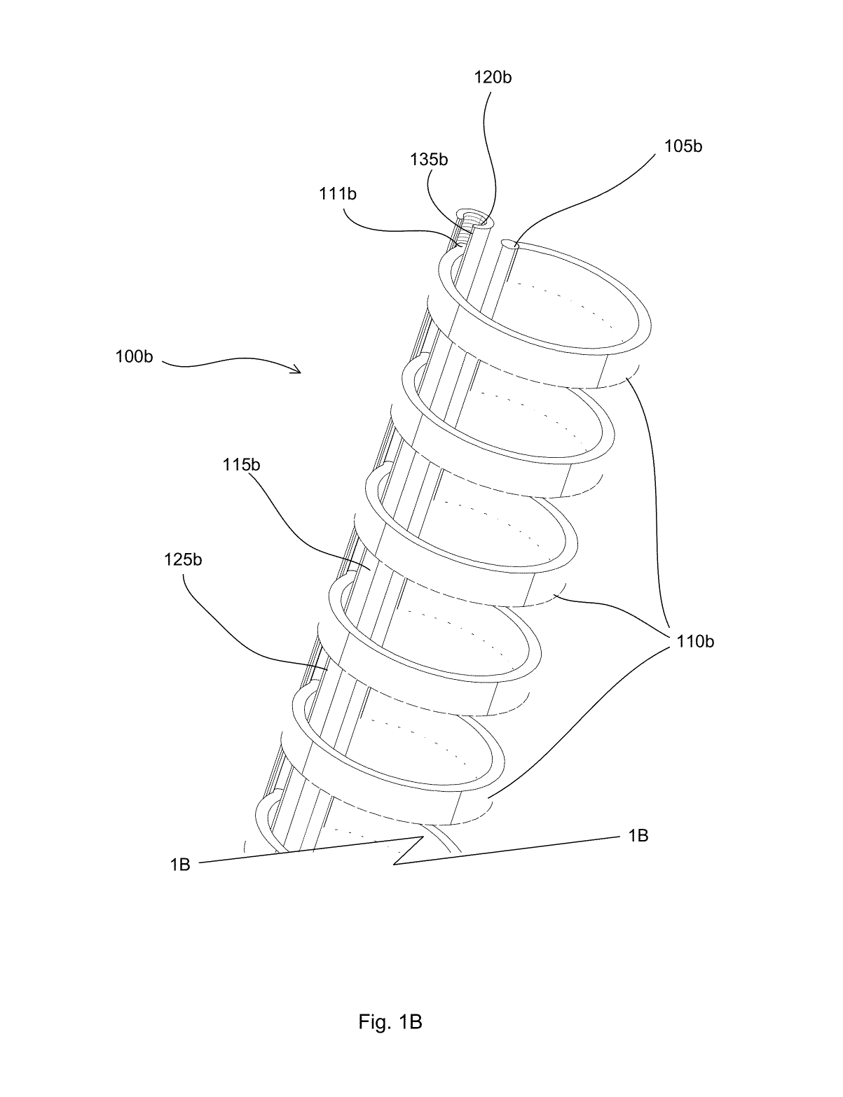

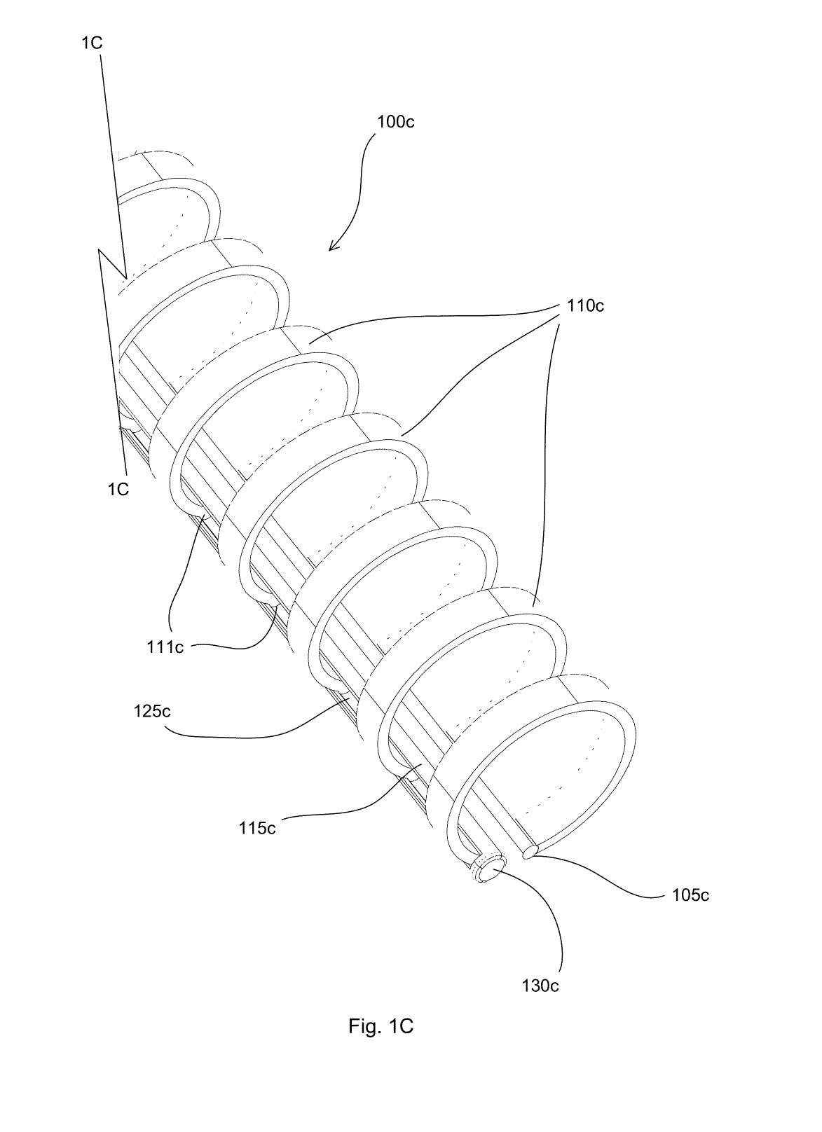

Turning to FIG. 1A, a loose-leaf paper binder 100a is depicted to include a main body including a backbone 105a with a plurality of rounded fingers 110a attached at a first end of each rounded finger. The loose-leaf paper binder 100a further includes a closure 115a having a longitudinally extending closure finger slot 125a, a closure open end 120a with a closure securing mechanism 135a and a closure stopping end 130a. As will be described in more detail herein, the closure is held in place via an enlarged second end of at least a portion of the rounded fingers 110. Although the rounded fingers are depicted as being rectangular in cross section, it should be understood that the rounded fingers may have a circular, square, triangular or any other polygon shape cross section.

With reference to FIG. 1B, an exploded view of a portion of a loose-leaf paper binder 100b is depicted. The portion of the loose-leaf paper binder 100b of FIG. 1B is the portion of the loose-leaf paper binder 100a of FIG. 1A from the section line 1B-1B toward the closure open end 120a. As can be seen in FIG. 1B, the loose-leaf paper binder 100b includes a plurality of rounded fingers 110b connected at a first end of each rounded finger to a backbone 105b. A second end of at least a portion of the rounded fingers 110b include an enlarged finger head 111b. A closure 115b includes a closure finger slot 125b and a closure open end 120b with a closure securing mechanism 135b. A loose-leaf paper binder may be configured such that a rounded finger at the end toward the closure open end includes an enlarged finger head 112b that is slightly larger than the remaining enlarged finger heads, such that the closure 115b is retained in position via friction fit between the enlarged finger head 112b and the closure securing mechanism 135b. Although the enlarged finger head is depicted as being a cylindrical shape, it should be understood that the enlarged finger head may be rectangular in cross section, square in cross section, triangular in cross section or may be any other polygon shape cross section. When the rounded fingers are circular in cross section, spherical shaped enlarged finger heads may be used.

With reference to FIG. 1C, an exploded view of a portion of a loose-leaf paper binder 100c is depicted. The portion of the loose-leaf paper binder 100c of FIG. 1C is the portion of the loose-leaf paper binder 100a of FIG. 1A from the section line 1C-1C toward the closure stopping end 130a. As can be seen in FIG. 1C, the loose-leaf paper binder 100c includes a plurality of rounded fingers 110c connected at a first end of each rounded finger to a backbone 105c. A second end of at least a portion of the rounded fingers 110c include an enlarged finger head 111c. A closure 115b includes a closure finger slot 125c and a closure stopping end 130c. A loose-leaf paper binder 100c may be configured with a first rounded finger 110c near the end having the closure open end, a second rounded finger 110c near the end having the closure stopping end and a third rounded finger 110c near a mid portion that include enlarged rounded finger heads 111c while the remaining rounded fingers do not have enlarged rounded finger heads. The closure finger slot 125c opens into an interior portion of the closure that includes an open area that is larger than the finger slot 125c. The closure 115c is placed parallel to the backbone 105c with the closure open end toward a first rounded finger. The closure 115c is then slid parallel to the backbone 105c with the enlarged rounded finger heads 111c being received within the enlarged interior portion of the closure 115c and a portion of the rounded fingers sliding through the closure slot 125 until the closure stopping end abuts the corresponding rounded finger. It should be understood that the shape of the cross section of the closure interior portion is matched to the cross section shape of the enlarged finger heads.

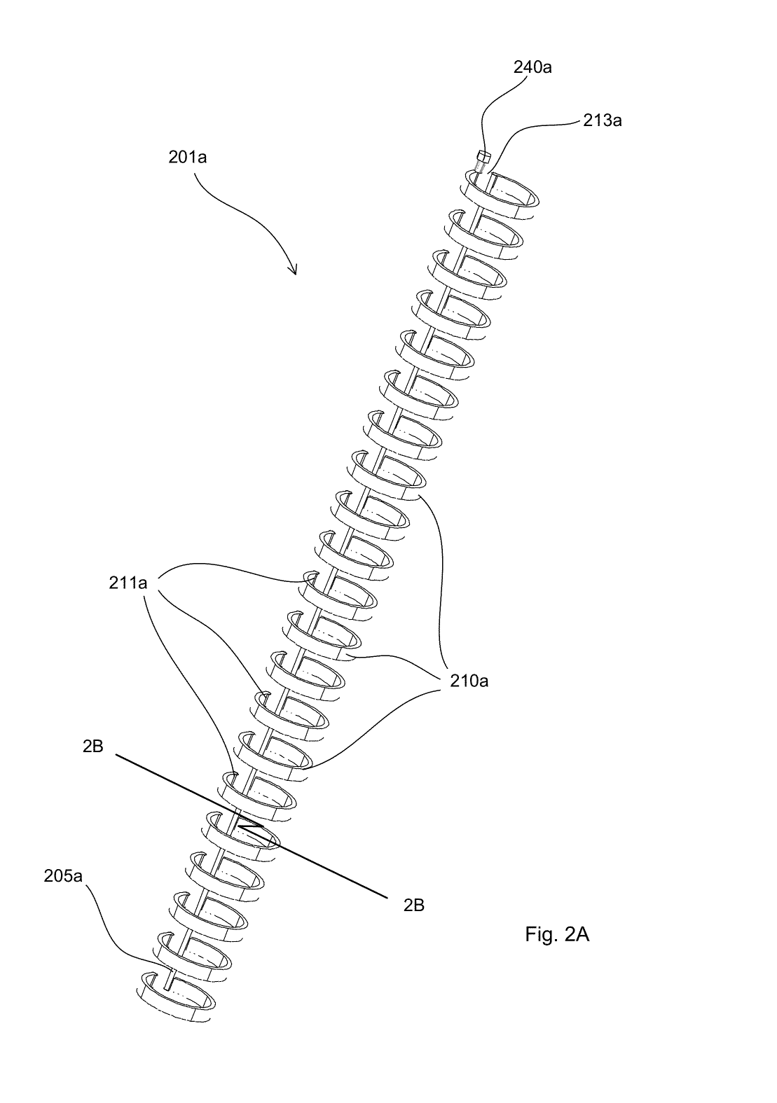

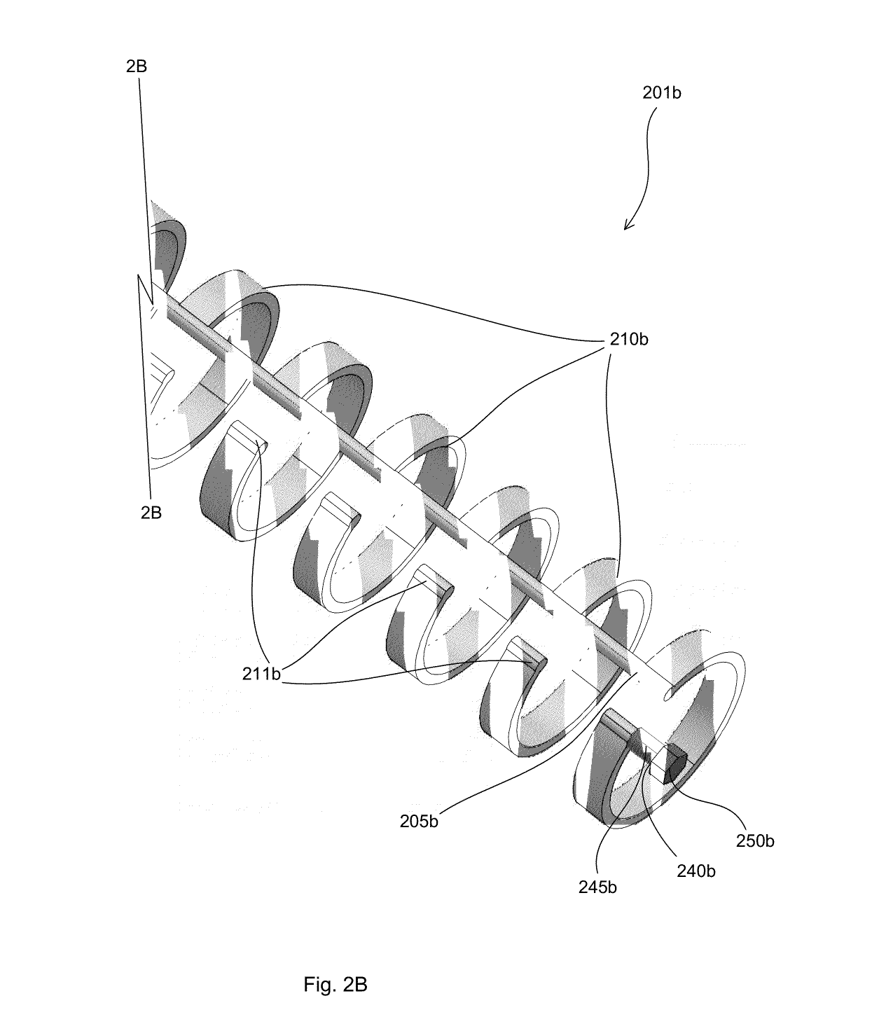

Turning to FIG. 2A, a loose-leaf paper binder main body 201a is depicted to include a plurality of rounded fingers 210a connected to a backbone 205a at a first end of each rounded finger 210a. A second end of each rounded finger 210a includes an enlarged finger head 211a. The gap 213a is wide enough for insertion and removal of paper, yet narrow enough to rotate pages front-to-back or back-to-front without folding the pages. A fastener 240a may be provided to secure a closure (not shown in FIG. 2A) in position with respect to the main body 201a. The fasterner 240a may be formed as an integral part of a corresponding enlarged finger head 211a on the end finger of the main body portion. It should be understood that the fastener 240a is not included in some loose-leaf paper binder assemblies.

FIG. 2B depicts a portion of a loose-leaf paper binder main body 201b. The portion of the loose-leaf paper binder main body 201b is a portion of the loose-leaf paper binder main body 201a of FIG. 2A from the section line 2B-2B extending to one end of the loose-leaf paper binder main body 201a. The portion of the loose-leaf paper binder main body 201b includes a plurality of rounded fingers 210b connected to a backbone 205b at a first end of each rounded finger 210b. Each rounded finger 210b includes an enlarged rounded finger head 211b. A closure fastener 240b is depicted proximate an enlarged rounded finger head 211b at the end of the loose-leaf paper binder main body 201b. The closure fastener 240b includes a fastener securing mechanism 245b and a fastener head 250b. The closure fastener 240b may be integrally formed with the corresponding enlarged rounded finger head 211b or may be a separate piece. In either event, the fastener securing mechanism 245b is configured to engage a corresponding closure securing mechanism (not shown in FIG. 2B). The fastener securing mechanism may be a threaded male portion configured to threadingly engage a corresponding female threaded closure securing mechanism. Alternatively, the fastener securing mechanism may form a friction and/or interference fit with a corresponding closure securing mechanism.

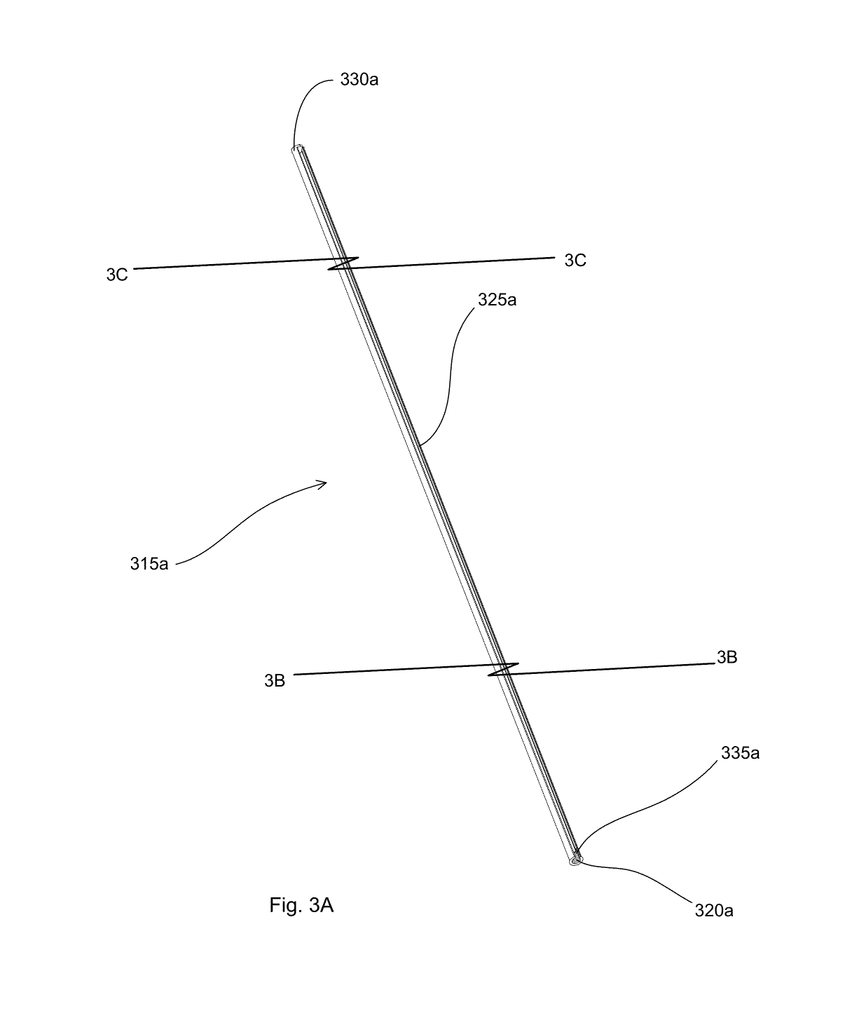

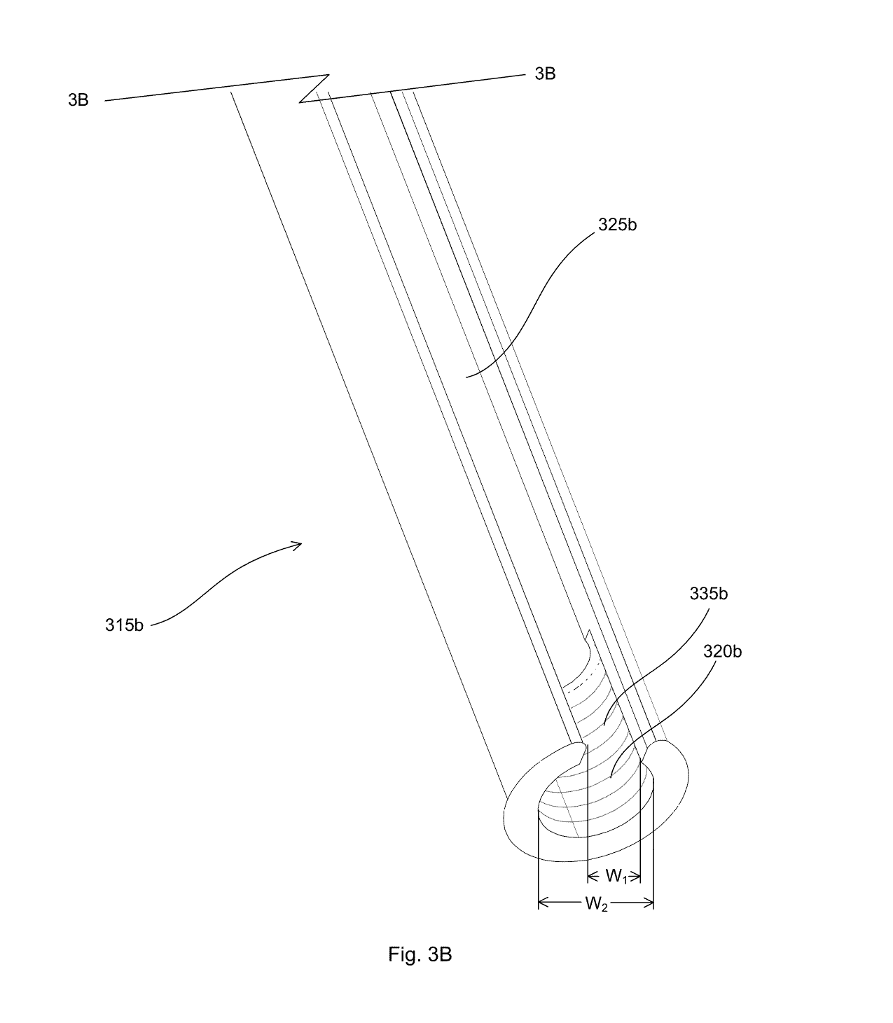

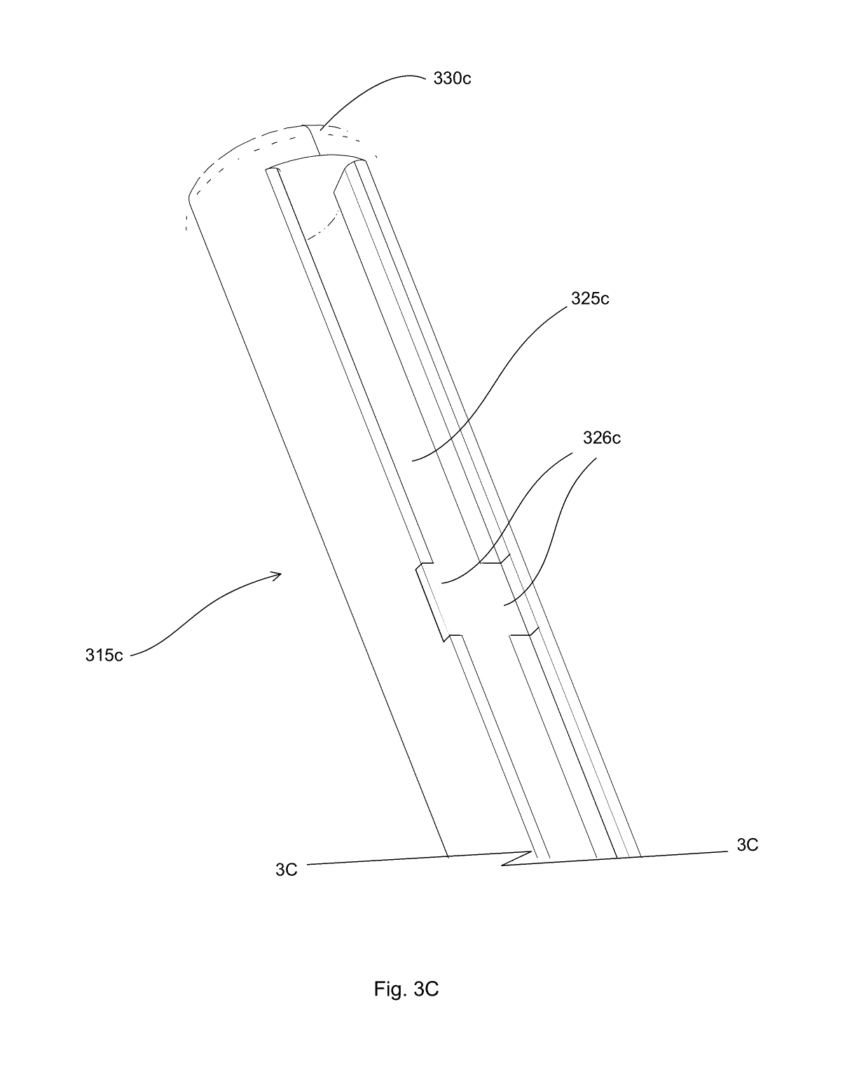

Turning to FIG. 3A, a closure 315a is depicted to include a closure finger slot 325a, a closure stopping end 330a and a closure open end 320a with a closure securing mechanism 335a. A closure may be provided with a closure finger slot that forms a friction and/or interference fit with a plurality of rounded finger ends such that the closure is secured to the loose-leaf paper binder main body. The closure finger slot may be discontinuous, having sections of the slot that are aligned with corresponding rounded fingers.

FIG. 3B depicts a portion of a closure 315b corresponding to a portion of the closure 315a of FIG. 3A extending from the section line 3B-3B to the closure open end 320a. The portion of the closure 315b is depicted to include a closure finger slot 325b and a closure open end 320b having a closure securing mechanism 335b. The width W₁ of the closure finger slot is less than the width W₂ of a closure interior portion. Corresponding enlarged rounded finger ends have a width less than width W₂ and greater than width W₁. Thereby, a closure may be slid parallel to a main body engaging corresponding enlarged rounded finger heads within the enlarged closure interior and the rounded fingers in the closure finger slot to secure the closure to the main body.

FIG. 3C depicts a portion of a closure 315c corresponding to a portion of the closure 315a of FIG. 3A extending from the section line 3C-3C to the closure open end 320a. The portion of the closure 315c is depicted to include a closure finger slot 325c and a closure stopping end 330c. A plurality of closure enlarged finger head apertures 326c may be formed in the closure slot 325c to receive corresponding enlarged rounded finger heads (not shown in FIG. 3C). Thereby, a closure 315c may be placed parallel to a loose-leaf paper binder main body with the enlarged rounded finger heads aligned with the closure enlarged finger head apertures and moved perpendicular such that the enlarged rounded finger heads are received within the closure enlarged finger head apertures. Subsequently, the closure is slid parallel to the main body a distance less than the distance between rounded fingers to secure the closure to the main body. Alternatively, the enlarged rounded finger heads may be wider than the closure slot and the closure may be made of a material that allows the closure slot to widen while the enlarged rounded finger heads are forced perpendicularly into the closure interior. Thereby, the closure is put in place simply by pressing the enlarged rounded finger heads into position without sliding the closure parallel to the loose-leaf binder main body.

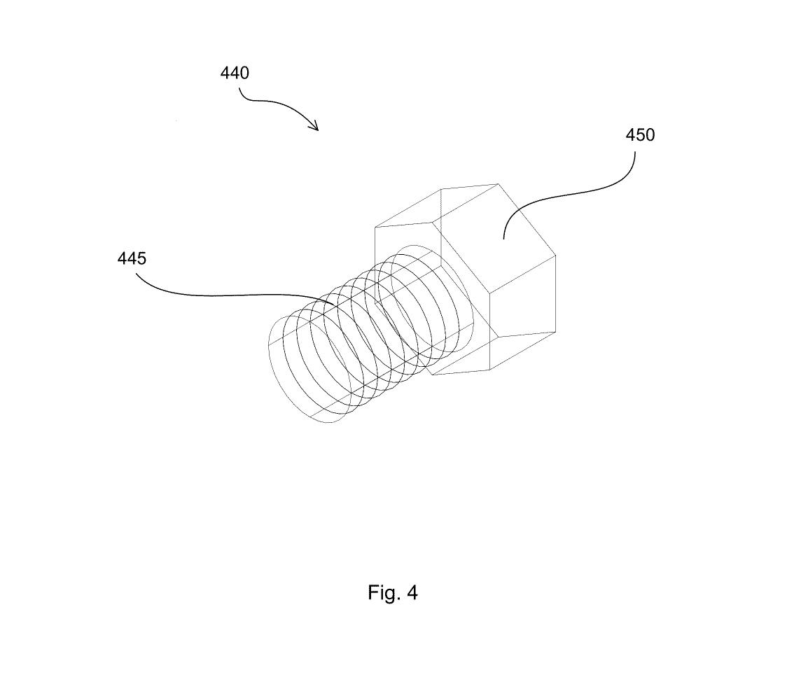

Turning to FIG. 4, a fastener 440 is depicted to include a fastener securing mechanism 445 and a fastener head 450. The fastener 440 may be provided to secure a closure in place with respect to a corresponding main body to form a loose-leaf paper binder.

As an alternative to the above mentioned structure, each enlarged finger head may include a hole extending through the enlarged finger head parallel to the backbone. A corresponding closure may then be an elongated rod that slides through the holes in the enlarged finger heads. It should be understood that the cross section of the holes in the enlarged finger heads and the elongated rod may be any shape, such as rounded, square, triangular or any other polygon shape. It should also be understood that the enlarged finger heads may form a hook shape and an elongated rod closure is configured to be removably secured to the hook shaped enlarged finger heads and spaced apart from the backbone.

A loose-leaf paper binder as described herein may be incorporated into a notebook system that allows full customization and rearrangement of paper, cover and accessories while being small, light, practical to use and able to be folded over.

Loose-leaf paper binders as described herein allow removing unused pages from a used notebook and reassembling into a new notebook. Eliminating unnecessary waste offers cost savings, and is good for the ecology. Since pages can be rearranged, there is no need to carry heavy loads of paper. Carrying one notebook per day is enough, even for multiple subjects, daily class notes can later be removed and stored in separate, larger sized loose-leaf paper binders as described herein. Loose-leaf paper binders as described herein may be similar in dimensions to traditional notebooks. The ring design holds the pages through numerous holes thus distributing tension and reducing pages that rip off. Loose-leaf paper binders as described herein may be un-bulky and easy to carry. Their closing mechanism can include sliding locks that are silent upon opening as opposed to traditional snap-open rings in binders. Loose-leaf paper binders as described herein have independent front and back covers (instead of a single, continuous piece). They can be folded over for maneuverability on school desks with limited writing surface. Additionally, the covers are not attached to the spine and can thus be fully customized by the user to display different colors, designs, etc. (one loose-leaf paper binder ring can display unlimited kinds of covers whereas a binder's cover is not customizable). The loose-leaf paper binders as described herein do not rely on slits on the pages for the rearrangement advantage; pages are fully locked into place at all times. The ability of the rings to hold the pages does not decrease after continued use. Fingers in the loose-leaf paper binders as described herein are not independent from each other, but rather joined together by a common backbone, this feature allows easy insertion and removal of multiple pages at once. Single or numerous pages can be aligned and inserted into the holding ring structure simultaneously and in a single motion (each ring does not need to be fitted individually).

The rounded fingers may be separated from each other by any given interval of space and may have any thickness and diameter according to the desired size of the items to hold (e.g. larger notebooks intended for storage of multiple subjects could have bigger fingers than those for single subjects intended for daily use). Additionally, there is no maximum or minimum limit to the amount of rounded fingers that can be attached to the backbone.

As previously mentioned, the fingers are semi-opened. On one end of the opening, the rings may have a wider section or enlarged finger head designed to hold the closure in place.

The loose-leaf paper binders as described herein may be made out of different materials. Different kinds of metal or plastics could be used to make all the elements described. The different elements could either be mold-formed together (e.g. rings with backbone forming the main body as a single piece) or connected by welding, adhesives, screws or other devices.

A person would first decide how many pages he or she would like to secure into the loose-leaf paper binders as described herein; the pages would then be inserted into the main body through the rings openings and secured in place by the closure. In the case the closure utilizes a sliding device, the closure piece would slide into place and then be secured by one of many mechanisms such as a screw, a rubber piece, etc. The user can decide to repeat the same process to customize the covers, dividers, folders and many other accessories as he or she sees fit.

Although its use as a notebook/paper binder is a possibility, the loose-leaf paper binders as described herein may have numerous other applications, including but not limited to its use as a calendar, planner, photo album, business card organizer, scrap book, key holder, organizing device to showcase pieces of fabric, etc. Educational kit systems, comprising all school supplies needed during the learning process, would benefit from the present invention by allowing students to carry around all the paper needed to take notes from different classes inside a single notebook; doing this would allow carriers to handle a lighter load, reorganize their pages later on in any desired order and have the additional benefit of economic savings as no page would ever remain unused. The invention could also benefit office filing systems, scrapbooking and planner systems by offering fully customizable contents, convenience and zero waste.

It is apparent that there has been provided, in accordance with the invention, a loose-leaf binder assembly that fully satisfies the objectives, aims, and advantages set forth above. While the invention has been described in conjunction with specific embodiments thereof, it is evident that many alternatives, modifications, and variations will be apparent to those skilled in the art in light of the a foregoing description. Accordingly, it is intended to embrace all such alternatives, modifications, and variations that fall within the spirit and scope of the appended claims.

What is claimed is:

1. A paper binder, comprising:
a main body comprising a plurality of fingers, said fingers comprise a first end connected to a backbone and at least a portion of said fingers comprise an enlarged second end, wherein said enlarged second end comprises an enlarged second end thickness that is larger than a finger thickness; and a closure comprising a slot and an interior portion, wherein a width of said slot is greater than the finger thickness and less than the enlarged second end thickness.

2. A paper binder as in claim 1 wherein said fingers comprise a circular shape.

3. A paper binder as in claim 1 wherein said enlarged second end comprises a cylindrical shape.

4. A paper binder as in claim 1 wherein said enlarged second end comprises a tapered rectangular cube shape.

5. A paper binder as in claim 1 wherein said slot comprises a plurality of receptacles, wherein a width of said receptacles is greater than the enlarged second end thickness.

6. A paper binder as in claim 1 further comprising a closure fastener.

7. A paper binder as in claim 1 wherein said fingers comprise a circular cross section.

8. A paper binder, comprising:
a main body comprising a plurality of fingers, said fingers comprise a first end connected to a backbone and at least a portion of said fingers comprise an enlarged second end, wherein said enlarged second end comprises an enlarged second end thickness that is larger than a finger thickness; and
a closure comprising a slot and an interior portion, wherein a width of said slot is greater than the finger thickness and less than the enlarged second end thickness, wherein an enlarged second end of the finger at the end of the main body corresponding to an open end of the closure includes a male fastener portion configured to engage a closure female fastener portion.

9. A paper binder as in claim 8 wherein said fingers comprise a circular shape.

10. A paper binder as in claim 8 wherein said enlarged second end comprises a cylindrical shape.

11. A paper binder as in claim 8 wherein said enlarged second end comprises a tapered rectangular cube shape.

12. A paper binder as in claim 8 wherein said slot comprises a plurality of receptacles, wherein a width of said receptacles is greater than the enlarged second end thickness.

13. A paper binder as in claim 8 further comprising a closure fastener.

14. A paper binder as in claim 8 wherein said fingers comprise a circular cross section.

15. A paper binder, comprising:
a main body comprising a plurality of fingers, said fingers comprise a first end connected to a backbone and at least a portion of said fingers comprise an enlarged second end, wherein said enlarged second end comprises an enlarged second end thickness that is larger than a finger thickness; and
a closure configured to be removably secured to the enlarged second ends and spaced apart from the backbone.

16. A paper binder as in claim 15 wherein said fingers comprise a circular shape.

17. A paper binder as in claim 15 wherein said enlarged second end comprises a cylindrical shape.

18. A paper binder as in claim 15 wherein said enlarged second end comprises a tapered rectangular cube shape.

19. A paper binder as in claim 15 wherein said slot comprises a plurality of receptacles, wherein a width of said receptacles is greater than the enlarged second end thickness.

20. A paper binder as in claim 15 wherein said fingers comprise a circular cross section.
